(19) United States
(12) Patent Application Publication
(10) Pub. No.: US 2013/0333584 A1
(43) Pub. Date: Dec. 19, 2013

(54) Method for storing printing plates successively removed from a plate cylinder of a rotary press and storage device

(71) Applicant: Goss International Corporation, (US)

(72) Inventors: Jean-Luc Bailly, Gorges (FR); Yves Didier Guy Harvard, La Chapelle Sur Erdre (FR)

(73) Assignee: Goss International Corporation, Durham, NH (US)

(21) Appl. No.: 13/871,724

(22) Filed: Apr. 26, 2013

(30) Foreign Application Priority Data
Apr. 27, 2012 (FR) 1253962

(51) Int. Cl. B41F 27/00

(52) U.S. Cl. CPC B41F 27/00
USPC 101/477; 101/483

(57) ABSTRACT

The present invention relates to a method for storing at least two printing plates (2) successively removed from a same plate cylinder (16) of a rotary press, each printing plate (2) having a central region (4) bearing patterns to be printed and a front edge (6) and a rear edge (8) opposite each other, the front edge being provided with a front fold (10) for fastening the printing plate (2) on the plate cylinder (16). According to the inventive method, the printing plates (2) are stacked on each other by fitting their front folds (10) into one another.

The present invention relates to a method for storing printing plates successively removed from a plate cylinder of a rotary press.

An offset rotary press comprises at least one printing group comprising a plate cylinder, on which printing plates are mounted bearing patterns to be printed, and a blanket cylinder bearing a blanket, the blanket cylinder being pressed against the plate cylinder and against a continuous strip to be printed, to transfer ink from the plates onto the strip and thus print the patterns on the strip.

To change edition or printing job, the used plates are removed from the plate cylinder and new plates are mounted on the plate cylinder.

EP 1,608,512 A1 discloses a system for changing plates for automatically mounting and removing plates on a plate cylinder of a rotary press. This plate changing system comprises a storage device for the plates successively removed from the plate cylinder, in which a subsequent plate, removed after a previous plate that has been removed beforehand, is stored below the previous plate. During the removing, the previous plate is raised and the following plate is slid under the previous plate.

Nevertheless, the pile of removed plates stacked on each other has a relatively significant height. This limits the number of plates that can be received in the storage device and requires operator intervention during production to remove the pile from the storage device. Increasing the height of the storage device increases its bulk.

One of the aims of the invention is to propose a method for storing plates successively removed from a plate cylinder of a rotary press, allowing storage of a larger number of plates in a smaller space.

To that end, the invention proposes a method for storing at least two printing plates successively removed from a same plate cylinder of a rotary press, each printing plate having a central region bearing patterns to be printed and a front edge and a rear edge opposite each other, the front edge being provided with a front fold for fastening the printing plate on the plate cylinder, in which the printing plates are stacked on each other by fitting their front folds into one another.

According to other embodiments, the method comprises one or more of the following features, considered alone or according to any technically possible combinations(s):
the printing plates are stacked by placing a subsequent printing plate on a previous printing plate that has previously been removed;
a subsequent printing plate is stored by sliding it from front to back on the previous printing plate until the front fold of the subsequent printing plate fits on the front fold of the previous printing plate;
the fold of each printing plate forms an acute angle with its central region when the central region lies flat, preferably an angle comprised between 30° and 90°;
each printing plate comprises a rear fold;
the printing plates are stored such that the rear fold of each subsequent printing plate rests on the previous printing plate stored beforehand;
the rear fold of each printing plate has a height smaller than that of the front fold when they are considered perpendicular to a plane in which the central region extends resting flat.

The invention also relates to a device for storing at least two printing plates successively removed from a same plate cylinder of a rotary press, each printing plate having a central region bearing patterns to be printed and a front edge and a rear edge opposite each other, the front edge comprising a front fold for catching on the plate cylinder, the storage device comprising a storage holder designed to receive the printing plates successively removed stacked on each other, the storage device comprising a movement system designed to move a subsequent printing plate when it is disassembled by sliding it toward the rear on a previous printing plate that has previously been disassembled, until the front fold of the subsequent printing plate is fitted on the fold of the previous printing plate.

According to other embodiments, the storage device comprises one or more of the following features, considered alone or according to any technically possible combinations(s):
the storage device comprises a recess at an inlet of the storage holder to allow the rear fold of the subsequent printing plate to slide above the front fold of the previous printing plate;
an inlet of the storage holder for the insertion of removed printing plates into the storage holder is situated above a horizontal tangent plane tangential to the plate cylinder and passing above it;
the storage device comprises a guide ramp extending between an inlet of the storage holder for the insertion of the removed printing plates in the storage holder and the circumference of the plate cylinder;
the recess is formed between an end of the storage holder adjacent to its inlet and an end of the guide ramp adjacent to that inlet;
the storage device comprises a movement device to move a printing plate partially inserted into the storage holder toward the bottom of the storage holder;
the storage device comprises at least one suction cup for gripping a printing plate through the action of the vacuum and a telescoping arm to move the suction cup;
the movement device is movable between a raised position away from the storage holder to free an inlet of the storage holder, and a lowered position to grasp and move a printing plate partially inserted into the storage holder.

The invention also relates to a rotary press comprising a storage device as defined above.

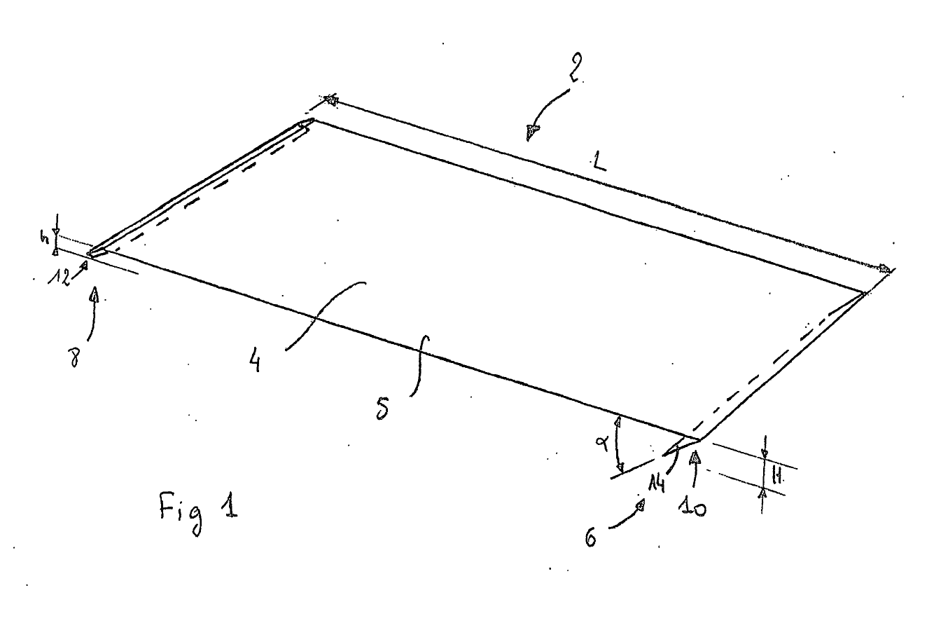

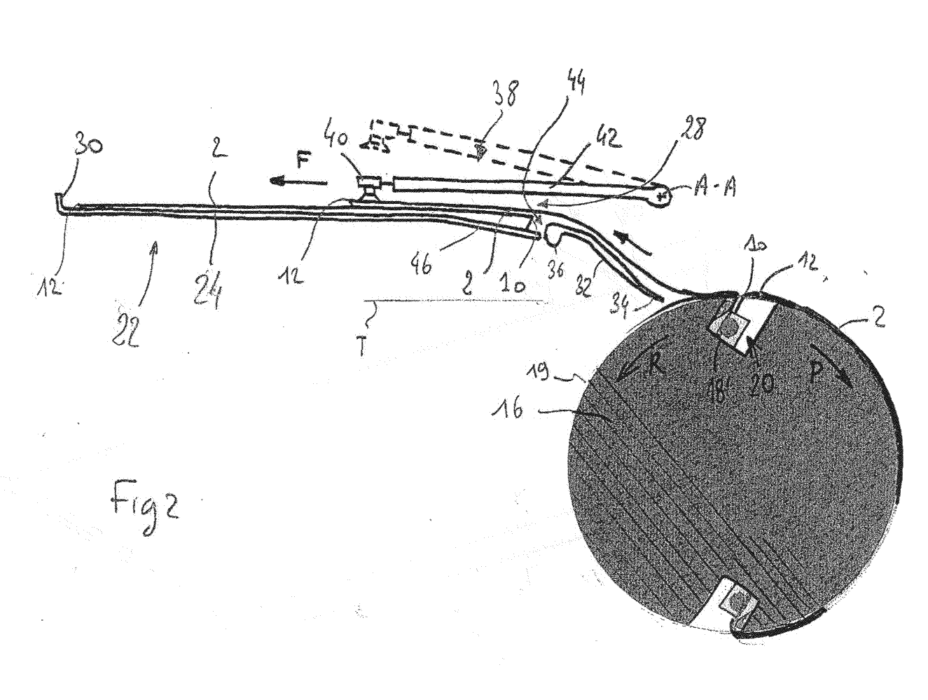

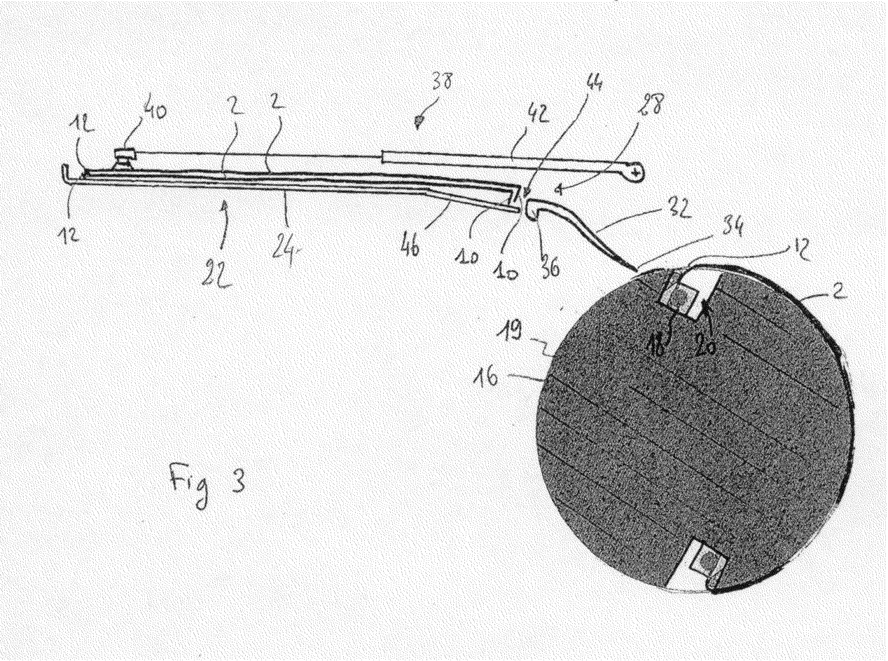

The invention and its advantages will be better understood upon reading the following description, provided solely as an example and done in reference to the appended drawings, in which:
FIG. 1 is a diagrammatic perspective view of a printing plate;
FIGS. 2 and 3 are side diagrammatic views of a plate cylinder and an associated system for unloading plates, illustrating the removing of plates from the plate cylinder.

The printing plate 2 illustrated in FIG. 1 is designed to be wound on a plate cylinder of an offset rotary printing press.

The plate 2 has a rectangular contour. The plate 2 comprises a central region 4 whereof an upper face 5 bears a pattern to be printed. The printing plate 2 comprises a front edge 6 and a rear edge 8 opposite each other, framing the central region 4. The front edge 6 is folded so as to form a front fold 10. The rear edge is folded so as to form a rear fold 12.

The terms “front” and “rear” are in understood in reference to the position of the plate 2 mounted on the plate cylinder and the direction of rotation of the plate cylinder during printing job.

The plate 2 extends longitudinally forward from its rear edge 8 and its front edge 6. The plate 2 has a length L considered between its rear edge 8 and its front edge 6.

The central region 4 is flexible so as to make it possible to wind the plate 2 on the circumference of a plate cylinder of a rotary press. The front fold 10 and the rear fold 12 are each permanently deformed such that the front fold 10 and the rear fold 12 are geometrically stable so as to make it possible to attach the plate on the plate cylinder.

The front fold 10 comprises a folded free branch 14. When the plate 2 is disassembled and placed flat, the free branch 14 forms an acute angle α with the central region 4 of the plate 2. The angle α is for example comprised between 30° and 90°. The front fold 10 for example comprises a single bend.

As illustrated in FIG. 1, the rear fold 12 comprises two bends.

As illustrated in FIG. 2, the plate 2 is designed to be wound on the circumference of a plate cylinder 16 of a rotary press 17. Each plate 2 is wound on the plate cylinder 16 while extending longitudinally along the circumference of the plate cylinder 16.

Each plate 2 mounted on the plate cylinder 16 is fastened by catching of its front fold 10 and its rear fold 12 in a fastening groove 18 formed in the outer surface 19 of the plate cylinder 16.

Each fastening groove 18 is provided to catch a front fold 10 of a plate 2 on an edge of the fastening groove 18, and is provided with a locking device 20 housed in the fastening groove 18 to retain a rear fold 12 of the same plate 2 or of another plate 2 received in the fastening groove 18. Each locking device 20 is selectively locked to retain the rear fold 12 received in the groove 24 or unlocked to free the rear fold 12.

The plate cylinder 16 is configured to bear one or more plates one behind the other on its circumference.

If the plate cylinder is designed to receive one plate per revolution, the plate cylinder 16 has a fastening groove 18 and the plate 2 is fastened on the plate cylinder with its front fold 10 and its rear fold 12 fastened in the fastening groove 18.

If the plate cylinder 16 is designed to receive several plates per revolution, the plate cylinder 16 has several fastening grooves 18, each plate 2 being mounted between two fastening grooves 18 and having its front fold 10 fastened in one fastening groove 18 and its rear fold 12 fastened in the other fastening groove 18.

During the performance of a printing job, the plate cylinder 16, bearing at least one plate 2 on its circumference, is rotated in the production direction illustrated by the arrow P in FIG. 2.

To change edition or printing jobs, at least one used plate 2 is removed from the plate cylinder 16, then replaced by a new plate 2 mounted on the plate cylinder 16.

The rotary press 17 comprises a storage device 22 associated with the plate cylinder 16 to automatically unload the plates 2 borne by the plate cylinder 16 and store them.

The storage device 22 comprises a storage holder 24 for storing several plates 2 stacked on each other.

The storage holder 24 is positioned near the plate cylinder 16 to be able to receive a plate 2 that is being removed and is still partially mounted on the plate cylinder 16.

The storage holder 24 extends substantially along a horizontal plane having an incline that is limited with respect to the horizontal, preferably less than +/−20°.

The storage holder 24 has an inlet 28 for inserting printing plates 2 into the storage holder 24. The inlet 28 is oriented toward the plate cylinder 16 so as to be able to receive a plate 2 that is being removed and is still partially mounted on the plate cylinder 16. The inlet 28 is situated above a horizontal tangent plane T tangential to the plate cylinder 16 and passing above the latter part. The storage holder 24 has a bottom 30 opposite the inlet 28.

The storage device 22 comprises a guide ramp 32 for guiding the rear edge 8 of a printing plate 2 during disassembly toward the inlet 28 of the storage holder 24. The ramp 32 extends between the inlet 28 and the circumference of the plate cylinder 16. The ramp 32 has a lower end 34 adjacent to the periphery of the plate cylinder 16 and an upper end 36 adjacent to the inlet 28 of the storage holder 24. The ramp 32 rises between its lower end 34 and its upper end 36.

Preferably, the ramp 32 is movable between an active position, in which its lower end 34 is adjacent to the circumference of the plate cylinder 16, and an inactive position (not shown), in which its lower end 34 is separated from the plate cylinder 16 during the performance of the print job.

The storage device 22 comprises a movement system 38 to move a plate 2 from the inlet 28 toward the bottom 30 of the storage holder 24.

The movement system 38 comprises at least one gripping member to grip a plate 2 and at least one movement actuator to move the or each gripping member.

As illustrated in FIGS. 2 and 3, a gripping member is a suction cup 40 that can be applied on a plate 2 to grip it by creating a vacuum between the suction cup and plate 2.

As illustrated in FIGS. 2 and 3, a movement actuator is a telescoping arm 42. Extending or retracting the telescoping arm 42 makes it possible to move the suction cup 40, and the plate 2 gripped by it, with respect to the storage holder 24. In the case at hand, extending the telescoping arm 42 makes it possible to move a plate 2 from the inlet 28 toward the bottom 30 of the storage holder 24, and retracting the telescoping arm 42 brings the suction cup 40 back toward the inlet 28 of the storage holder 24.

The movement system 38 is movable between a raised position (in dotted lines in FIG. 2), in which it is separated from the storage holder 24, and a lowered position, in which the gripping member is capable of gripping a plate 2 at least partially inserted into the storage holder 24. The movement system 38 pivots around a pivot axis A-A between the lowered position and the raised position.

The storage device 22 is adapted to store two plates 2 successively unloaded from the plate cylinder 16 by stacking them on one another in the storage holder 24 and fitting their front folds 10 into one another, such that the front fold 10 of a plate 2 stacked on another plate 2 is fitted on the front fold 10 of that other plate 2.

FIGS. 2 and 3 illustrate a first plate that has already been removed from the plate cylinder 16 and stored in the storage holder 24, and steps for removing a second plate and stacking it on the first plate in the storage holder 24. Hereafter, the first plate is called the “previous plate” and the second plate is called the “subsequent plate.”

In FIG. 2, the previous plate 2 is fully received in the storage holder 24 and the subsequent plate 2 is partially removed.

To remove the subsequent plate 2, the plate cylinder 16 is oriented around its axis such that the fastening groove 18 retaining the rear fold 12 of the subsequent plate 2 is substantially across from the storage device 24. The locking device 20 of the fastening groove 18 retaining the rear fold 12 of the subsequent plate 2 is unlocked so as to free that rear fold 12. Due to the inherent elasticity of the subsequent plate 2, the rear fold 12 rises. If necessary, a removal device is provided to act positively on the rear fold 12 to cause it to leave the fastening groove 18.

Next, the plate cylinder 16 is rotated backward R, in the direction opposite the direction of rotation P of the plate cylinder during the performance of the print job. Due to the rotation of the plate cylinder 16, the rear fold 12 moves toward the inlet 28 of the storage holder 24 while being guided by the guide ramp 32. It will be noted that the movement system 38 is in the raised position (in dotted lines in FIG. 2) so as not to hinder the insertion of the plate 2 into the inlet 28 of the storage holder 24.

The rear fold 12 of the subsequent plate 2 passes above the front fold of the previous plate 2 that has previously been disassembled. The storage device 22 comprises a recess 44 at the inlet 28 of the storage holder 24, in which the front fold 10 of the previous plate 2 stored in the storage holder 24 is received, which makes it possible to ensure that the rear fold 12 of the subsequent plate effectively passes on top. The storage holder 24 here comprises an end 46 adjacent to the inlet 28 inclined downward toward the inlet 28 to form a recess with the upper end 36 of the ramp 32.

Once the subsequent plate 2 is partially engaged in the storage holder 24, the movement system 38 is moved into the lowered position and the suction cup 40 is commanded to grip a rear part of the subsequent plate 2, as illustrated in FIG. 2.

Next, the telescoping arm 42 is commanded to move the suction cup 40 and the subsequent plate 2 toward the bottom 30 of the storage holder 24, as illustrated by arrow F, until the subsequent plate 2 is fully inserted into the storage holder 24. At the same time, the plate cylinder 16 continues to rotate backward R to free the front fold 10 of the subsequent plate 2.

During the movement of the subsequent plate 2 toward the bottom 30 of the storage holder 24, the subsequent plate 2 slides on the previous plate 2, above the latter. The subsequent plate 2 is stored in the storage holder 24 while being stacked and the previous plate 2 by resting in contact there on.

The subsequent plate 2 is pushed into the storage holder 24 until its front fold 10 fits on that of the previous plate 2, as illustrated in FIG. 3. The front fold 10 of the previous printing plate 2, situated below, is fitted into the front fold 10 of the subsequent printing plate, situated above.

With such a storage method, the rear fold 12 of a subsequent plate 2 stacked on a previous plate 2 rests on the previous plate 2 without fitting on the rear fold 12 of said previous printing plate.

As illustrated in FIG. 1, in general, the front 10 and rear 12 folds of the plates 2 are configured with a greater front folding height H to allow catching and lateral positioning of the plate on the plate cylinder along the axis of the plate cylinder, and a smaller rear folding height h for simple catching. Such a configuration is very favorable to stacking on top with fitting of the front folds 10 and makes it possible to reduce the volume of the stack of plates disassembled during the production.

Thus, a pile of printing plates 2 having a front folds 10 fitted together may receive a large number of printing plates 2 in a smaller space. Thus, it is not necessary for an operator to remove the disassembled printing plates during production, but only at the end of production.

The storage device makes it possible to store printing plates successively disassembled from a same plate cylinder, whether they are printing plates mounted one behind the other on the circumference of the plate cylinder with several printing plates per revolution and used for a same printing job, or printing plates used in several successive print jobs, done with a plate cylinder with several plates per revolution or one plate per revolution.

What is claimed is:

1. A method for storing at least two printing plates (2) successively removed from a same plate cylinder (16) of a rotary press, each printing plate (2) having a central region (4) bearing patterns to be printed and a front edge (6) and a rear edge (8) opposite each other, the front edge being provided with a front fold (10) for fastening the printing plate (2) on the plate cylinder (16), in which the printing plates (2) are stacked on each other by fitting their front folds (10) into one another.

2. The method according to claim 1, wherein the printing plates (2) are stacked by placing a subsequent printing plate (2) on a previous printing plate (2) that has previously been removed.

3. The method according to claim 1, wherein a subsequent printing plate (2) is stored by sliding it from front to back on the previous printing plate (2) until the front fold (10) of the subsequent printing plate (2) fits on the front fold (10) of the previous printing plate (2).

4. The method according claim 1, wherein the front fold (10) of each printing plate (2) forms an acute angle (α) with its central region (4) when the central region (4) lies flat, preferably an angle (α) comprised between 30° and 90°.

5. The method according to claim 1 any one of the preceding claims, wherein each printing plate comprises a rear fold (12).

6. The method according to claim 5, wherein the printing plates are stored such that the rear fold of each subsequent printing plate rests on the previous printing plate stored beforehand.

7. The method according to claim 5, wherein the rear fold (12) of each printing plate (2) has a height (h) smaller than that (H) of the front fold (10) when they are considered perpendicular to a plane in which the central region (4) extends resting flat.

8. A device for storing at least two printing plates successively removed from a same plate cylinder (16) of a rotary press, each printing plate (2) having a central region (4) bearing patterns to be printed and a front edge (6) and a rear edge (8) opposite each other, the front edge comprising a front fold (10) for catching on the plate cylinder, the storage device comprising a storage holder (24) designed to receive the printing plates (2) successively removed stacked on each other, the storage device comprising a movement system (38) designed to move a subsequent printing plate (2) when it is removed by sliding it toward the rear on a previous printing plate (2) that has previously been removed, until the front fold (10) of the subsequent printing plate (2) is fitted on the fold of the previous printing plate (2).

9. The storage device according to claim 8, comprising a recess (44) at an inlet (28) of the storage holder (24) to allow the rear fold of the subsequent printing plate (2) to slide above the front fold (10) of the previous printing plate (2).

10. The storage device according to claim 8, wherein an inlet (28) of the storage holder (24) for the insertion of removed printing plates into the storage holder (24) is situated above a horizontal tangent plane (T) tangential to the plate cylinder (16) and passing above it.

11. The storage device according to claim 8, comprising a guide ramp (32) extending between an inlet of the storage holder (24) for the insertion of the removed printing plates in the storage holder (24) and the circumference of the plate cylinder (16).

12. The storage device according to claim 9, wherein the recess is formed between an end of the storage holder (24) adjacent to its inlet (28) and an end of the guide ramp (32) adjacent to that inlet (28).

13. The storage device according to claim 8, comprising a movement device to move a printing plate (2) partially inserted into the storage holder (24) toward the bottom (30) of the storage holder (24).

14. The storage device according to claim 13, comprising at least one suction cup (40) for gripping a printing plate (2) through the action of the vacuum and a telescoping arm (42) to move the suction cup (40).

15. The storage device according to claim 13, wherein the movement device is movable between a raised position away from the storage holder (24) to free an inlet (28) of the storage holder, and a lowered position to grasp and move a printing plate (2) partially inserted into the storage holder (24).

16. A rotary press comprising a storage device according to claim 8.
